(19) United States
(12) Patent Application Publication
(10) Pub. No.: US 2026/0251621 A1
(43) Pub. Date: Aug. 27, 2026

(54) PIPELINE MONITORING BASED ON ULTRASONIC GUIDED ACOUSTIC WAVE AND FIBER OPTIC SENSOR

(71) Applicant: UNIVERSITY OF PITTSBURGH-OF THE COMMONWEALTH SYSTEM OF HIGHER EDUCATION, PITTSBURGH, PA (US)

(72) Inventors: Paul R. Ohodnicki, JR., Allison Park, PA (US); Nageswara Rao Lalam, Dravosburg, PA (US); Ruishu Wright, Venetia, PA (US); Pengdi Zhang, Pittsburgh, PA (US)

(73) Assignee: UNIVERSITY OF PITTSBURGH-OF THE COMMONWEALTH SYSTEM OF HIGHER EDUCATION, PITTSBURGH, PA (US)

(21) Appl. No.: 19/160,156

(22) PCT Filed: Mar. 26, 2024
(86) PCT No.: PCT/US2024/021459

§ 371 Date: Aug. 27, 2025

Related U.S. Application Data
(60) Provisional application No. 63/456,230, filed on Mar. 31, 2023.

(51) Int. Cl. G01N 29/24; G01N 29/04; G01N 29/44

(52) U.S. Cl. CPC G01N 29/2418; G01N 29/04; G01N 29/4481; G01N 2291/023; G01N 2291/0234; G01N 2291/0289; G01N 2291/2634

(57) ABSTRACT

A system for monitoring the structural health a pipeline includes a wave assembly for exciting the pipeline with acoustic waves, a number of sensor assemblies each including one or more fiber optic cable sensing devices, a light source for providing interrogation light to the sensor assemblies, and a detector coupled to the sensor assemblies. The detector is configured for receiving an output of the sensor assemblies responsive to the interrogation light in an active mode of operation while a portion of the pipeline is being excited with the acoustic waves, and in response thereto generating active sensor data. The system also includes a controller coupled to the detector, wherein the controller is configured for receiving the active sensor data, and for analyzing the active sensor data and detecting a defect in the portion of the pipeline based on the analyzing

### CROSS REFERENCE TO RELATED APPLICATIONS

This application claims priority to U.S. Provisional Patent Application Ser. No. 63/456,230, filed on Mar. 31, 2023 and titled “Pipeline Monitoring Based on Ultrasonic Guided Acoustic Wave and Fiber Optic Sensor Fusion,” the disclosure of which is incorporated herein by reference.

### STATEMENT OF GOVERNMENT INTEREST

This invention was made with government support under grant numbers 89243318CFE000003 and DE-AR0001332 awarded by the U.S. Department of Energy. The government has certain rights in the invention.

### FIELD OF THE INVENTION

The disclosed concept relates generally to pipelines, and, in particular, to a system and method for monitoring the health of pipelines using ultrasonic guided waves, fiber optic based sensors (e.g., for sensing strain, temperature or acoustic parameters), and distributed and/or quasi-distributed sensing technologies.

### BACKGROUND OF THE INVENTION

Pipelines are critical for the transportation and distribution of liquid and gaseous fuel in various industrial sectors, including the oil, gas, and petrochemical sectors. Such pipelines, however, have been laid across diverse and often harsh terrains, making it challenging to maintain their structural integrity. To safeguard national security and economic growth, it is important to study and develop comprehensive monitoring methods that can detect and mitigate external threats, such as sabotage, unauthorized access, construction accidents, and natural disasters, as well as internal structural degradation caused by various factors such as corrosion, erosion, fatigue, and material degradation due to environmental and/or operational factors.

Different technology-driven and human-operated evaluation programs have been employed to protect pipeline infrastructure for many years. Currently, structural health monitoring (SHM) is a technology that integrates sophisticated sensor systems with intelligent algorithms to assess the “health” of a structure. This approach has the potential to enhance reliability and safety, optimize performance, increase automation capabilities, and decrease overall lifecycle costs. As such, SHM has garnered significant interest in recent years and is now recognized as a promising solution for improving the structural integrity of civil infrastructure, aerospace, and mechanical systems. In these applications, damage detection by guided-wave nondestructive testing has attracted widespread interest. Ultrasonic sensors can detect the backscattering acoustic response in pipelines, which provides data for identifying different events, such as structural damage or changes in structure of a pipeline, like the addition of clamps or the presence of welds within the structure.

Elastic perturbations known as guided waves are capable of propagating over extended distances in thin-walled structures while experiencing minimal amplitude loss. Laboratory settings (for example, as described in D. Rezaei and F. Taheri, “A Novel Application of a Laser Doppler Vibrometer in a Health Monitoring System,” J. Mech. Mater. Struct., vol. 5, pp. 289-304, 2010) have demonstrated the efficiency of using guided acoustic waves to detect and locate pipeline anomalies in critical areas that are susceptible to defects. Also, guided wave nondestructive examination (NDE) has the potential to significantly decrease the number of sensors necessary for monitoring a structure. Specifically, guided wave NDE technology is a promising method for SHM, but one of the main limitations is the size and cost of deploying conventional NDE sensors ubiquitously. In guided acoustic wave sensing, the exciting transducer is therefore typically also used as the measurement sensor, thereby measuring the backscattered acoustic wave. Such an installation scenario can be highly limiting in terms of investigating damage over large distances and in remote locations, and the amount of information that can be extracted is also limited by what can be measured at the excitation location.

### SUMMARY OF THE INVENTION

In one embodiment of the disclosed concept, a system for monitoring structural health of a portion of a pipeline is provided. The system includes a wave assembly structured and configured for exciting the portion of the pipeline with acoustic waves, a number of sensor assemblies coupled to the portion of the pipeline, each of the sensor assemblies including one or more fiber optic cable sensing devices, a light source structured and configured for providing interrogation light to the number of sensor assemblies, a detector coupled to the number of sensor assemblies, the detector being structured and configured for receiving an output of the number of sensor assemblies responsive to the interrogation light in an active mode of operation while the portion of the pipeline is being excited with the acoustic waves, and in response thereto generating active sensor data, and a controller coupled to the detector, wherein the controller is structured and configured for receiving the active sensor data, and for analyzing the active sensor data and detecting a defect in the portion of the pipeline based on the analyzing.

In another embodiment of the disclosed concept, a method of monitoring the structural health of a portion of a pipeline is provided. The method includes coupling a number of sensor assemblies to the portion of the pipeline, each of the sensor assemblies including one or more fiber optic cable sensing devices, exciting the portion of the pipeline with acoustic waves, providing interrogation light to the number of sensor assemblies, receiving an output of the number of sensor assemblies responsive to the interrogation light in an active mode of operation while the portion of the pipeline is being excited with the acoustic waves, and in response thereto generating active sensor data, and receiving the active sensor data, and analyzing the active sensor data and detecting a defect in the portion of the pipeline based on the analyzing.

### BRIEF DESCRIPTION OF THE DRAWINGS

A full understanding of the invention can be gained from the following description of the preferred embodiments when read in conjunction with the accompanying drawings in which:

FIG. 1 is a schematic diagram of a pipeline infrastructure monitoring system according to an exemplary embodiment of the disclosed concept;

FIG. 2 is a schematic diagram of a monitoring system deployed in connection with an exemplary portion of a pipeline for monitoring the health status of the pipeline according to an exemplary embodiment of the disclosed concept; and

FIG. 3A and FIG. 3B show an exemplary excitation signal, in the time domain and frequency domain, respectively that may be employed in connection with the disclosed concept;

FIG. 4 is a schematic diagram of an exemplary sensing element comprising an SNS fiber structure that may be employed in connection with the disclosed concept;

FIG. 5 depicts a time-space data matrix as input to a CNN network that may be employed in connection with the disclosed concept according to an exemplary embodiment;

FIG. 6 is a schematic diagram of an exemplary CNN architecture that may be used to implement the disclosed concept;

FIG. 7 is a schematic diagram of one particular exemplary CNN architecture that may be used to implement the disclosed concept;

FIG. 8 is a schematic diagram of an exemplary embodiment of the disclosed concept in which a quasi-distributed sensor is arranged axially along a pipeline;

FIG. 9 is a schematic diagram of another exemplary embodiment of the disclosed concept in which a fully distributed sensor is arranged axially along a pipeline;

FIG. 10 is a schematic diagram of another exemplary embodiment of the disclosed concept in which a quasi-distributed sensor is arranged spirally or helically along a pipeline; and

FIG. 11 is a schematic diagram of another exemplary embodiment of the disclosed concept in which a fully distributed sensor is arranged spirally or helically along a pipeline 10.

### DETAILED DESCRIPTION OF THE INVENTION

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, “directly coupled” means that two elements are directly in contact with each other.

As used herein, the term “number” shall mean one or an integer greater than one (i.e., a plurality).

As used herein, the terms “component” and “system” are intended to refer to a computer related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term “no-core fiber” or “NCF” shall mean an optical fiber in which there is no core/cladding structure such that the medium surrounding the fiber serves as the effective cladding.

As used herein, the term “single-mode fiber” or “SMF” shall mean an optical fiber in which a dominant single propagating mode is guided within the fiber (even if additional modes are present).

As used herein, the term “multi-mode fiber” or “MMF” shall mean an optical fiber in which numerous (i.e., a plurality of) modes are guided within the fiber.

As used herein, the term “single-mode-no-core-single mode (SNS) fiber structure” shall mean a fiber optic structure that includes a no-core fiber that is provided between and directly or indirectly coupled to two single-mode fibers at opposite ends of the no-core fiber such that an optical path is created from one single-mode fiber to the other single-mode fiber through the no-core fiber.

As used herein, the term “single-mode-multi-mode-single mode (SMS) fiber structure” shall mean a fiber optic structure that includes a multi-mode fiber that is provided between and directly or indirectly coupled to two single-mode fibers at opposite ends of the multi-mode fiber such that an optical path is created from one single-mode fiber to the other single-mode fiber through the multi-mode fiber.

As used herein, the term “quasi-distributed fiber optic sensing” shall mean sensing based on measurements of discrete sensor element(s) provided within or coupled to one or more fiber optic cables at a plurality of distinct locations to allow for measuring parameters both temporally and in a spatially distributed manner.

As used herein, the term “quasi-distributed fiber optic sensor” shall mean a fiber optic cable sensing device that employs quasi-distributed fiber optic sensing.

As used herein, the term “distributed fiber optic sensing” shall mean sensing parameters along the length of a fiber optic cable wherein the entire fiber optic cable acts as an array of sensing elements.

As used herein, the term “distributed fiber optic sensor” shall mean a fiber optic cable sensing device that employs distributed fiber optic sensing.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific details in order to provide a thorough understanding of the subject invention. It will be evident, however, that the disclosed concept can be practiced without these specific details without departing from the spirit and scope of this innovation.

The disclosed concept, as described in detail herein, combines advantages of distributed and quasi-distributed optical fiber sensing with active and controlled excitation conditions enabled by guided wave acoustic NDE for probing pipeline infrastructure asset state-of-health, with emphasis on pipelines. To achieve highly efficient data analysis and interpretation and maximize information extracted, physics-based modeling with advanced data analytics methods including reduced order modeling and classification framework development based upon artificial intelligence and machine learning can, in certain embodiments, also be applied. In the exemplary embodiment, the disclosed concept provides a machine-learning-based framework for detecting mechanical damage in pipelines, utilizing Physics-informed datasets collected from simulations of mechanical damage of example pipelines. The framework provides an effective workflow from dataset generation to damage detection and identification for pipeline events, including but not limited to: welds, clamps, and corrosion defects (including localized corrosion, general corrosion, and pitting corrosion).

Structural discontinuities can arise from variations in material properties, such as a structure that is partially embedded in a surrounding medium. To represent practical scenarios, as just noted, exemplary embodiments of the disclosed concept include three types of pipeline events: welds, clamps, and corrosion defects. As one example, the weld can be modeled as a narrow cylinder with a constant inside diameter that protrudes through the weld and connects to the pipe, with an outside diameter larger than that of the pipe. As another example, the clamps on the pipeline can be modeled with a specific surface connected to the pipe and a stiffness ratio determined by constraint of the clamps. The categorization of corrosion can be based on the classification proposed by M. Askar, “A comprehensive review on internal corrosion and cracking of oil and gas pipelines”, Journal of Natural Gas Science and Engineering, Vol. 71, November 2019, which includes three main types: localized, general, and pitting corrosion. Localized corrosion is mainly due to damage to the surface in the form of mass removal in selected areas, resulting in formation of pits, cracks, and grooves. Pitting is a form of localized corrosion damage that results in the formation of small defects or pits. The disclosed concept differentiates between types of corrosion due to their significant differences in size. Pitting corrosion typically has a size in the hundreds of micrometers range, making it a challenge for finite element analysis (FEA) models due to need for fine meshing in proximity to the defect and relatively weak scattering signature. General corrosion is another type that occurs in a relatively large area caused by several electrochemical processes occurring consistently over the entire surface under consideration. In this type, key characteristics are the loss of metal thickness and unit weight, both of which can have a measurable signature in an acoustic signal to reflect specific characteristics.

Moreover, in an exemplary embodiment, a fiber optic acoustic sensor is employed in combination with ultrasonic guided acoustic wave monitoring for pipeline health monitoring applications. The sensor can be comprised of any in-fiber device for which ultrasonic frequencies can be successfully interrogated, including, but not limited to, multimode interferometers, fiber Bragg gratings (FBGs), and Fabry Perot interferometers. As stated elsewhere herein, an SMS device is an example of a suitable fiber optic acoustic sensor. The SMS fiber structure of the exemplary embodiment consists of an MMF sandwiched between two SMFs. Whenever the MMF fiber experiences vibration disturbances, the fiber experiences tensile and compressive strains. By demodulating the vibration-induced intensity fluctuations, the vibrations signals can be quantified. Through employing several SMS sensors in parallel and connecting and controlling the sensor by an optical switch, quasi-distributed sensing can be realized. The disclosed sensor system has been demonstrated in a laboratory environment to have the capability of detecting a wide range of vibration frequencies from 10 Hz to 1 MHz. In addition, an exemplary fiber sensor system according to the disclosed concept has been field-tested, where several SMS fiber sensors were mounted on 8.5″ diameter steel pipe and excited with acoustic emissions based on a magnetostrictive guided wave collar system. The disclosed highly sensitive fiber sensor is one example that can potentially be used in practical applications of pipeline health condition monitoring.

Alternative high frequency compatible optical fiber sensing configurations can also be considered, including Fabry Perot interferometers, fiber Bragg gratings, and fully distributed interrogation methodologies. The active sensing can also be combined with passive monitoring (without the excitation with acoustic waves) to allow for complementary information about the pipeline state of health. Thus, in a system according to the disclosed concept, the detector may also be structured and configured for receiving an output of a number of sensor assemblies responsive to interrogation light in a passive mode of operation while the pipeline is not being excited with the acoustic waves, and in response thereto generate passive sensor data, and the controller may be structured and configured for receiving the passive sensor data and analyzing the active sensor data and the passive sensor data and detecting a defect in the portion of the pipeline based on both types of data. The sensing configuration of the disclosed concept can also be combined with physics-based models, machine learning, and artificial intelligence methods to enable extraction of detailed information about pipeline structural health based upon both the active excitation modes of interrogation and known/inferred acoustic signatures.

In addition, the use of a magnetostrictive collar to couple the UGWs into the pipeline being tested offers an alternative to traditional piezoelectric collars for long-range acoustic signal transmission as well as flaw detection within the pipe. In the disclosed concept, the magnetostrictive collar acts as a transmitter of the acoustic signal down the pipe and as a receiver for the reflected signals from defects within the pipe. While the technique has demonstrated significant merit for non-destructive evaluation (NDE), a primary limitation is the single point sensing capability. In contrast, the concept of integrating acoustic guided wave technology with fiber optic sensors (i.e., guided acoustic wave NDE/fiber optic sensing fusion) is a largely unexplored area of research, with great potential for enhancing the capability in applications such as pipeline monitoring by combining the highly controlled and well-characterized guided acoustic ultrasonic wave with the spatially distributed monitoring capability of the optical fiber sensor platform.

For crack or damage detection of structures, high frequency acoustic waves are often utilized to provide for sufficient spatial resolution and to excite allowed guided modes within structures of finite dimensions, with typical frequencies ranging from tens of kHz to several hundreds of kHz, which presents a challenge for conventional fiber-optic acoustic sensing technology. The disclosed concept, as described in detail herein, provides a vibration sensor system with a wide frequency measurement range and multiplexing capability for multipoint measurements. In particular, the acoustic/vibration sensor configuration of the disclosed concept includes a high frequency compatible point, quasi-distributed and/or fully distributed fiber structure, which offers some unique advantages, such as ease of fabrication, low cost, flexible design, and high sensitivity. As one example, an SMS fiber sensor according to the disclosed concept is capable of wide frequency detection from 10 Hz up to 400 kHz. As noted above, the disclosed concept may employ physics-based modeling, machine learning and artificial intelligence based frameworks, and an understanding of specific defect or fault condition signatures in order to enhance the value of the information generated. Similarly, sensitive acoustic signatures of third-party intrusion detection can also be measured and classified. Ultimately, better prediction of the remaining service life of the pipe, as well as increased service lifetime through enhanced risk assessment and quantification, can be achieved through further maturation and ultimately deployment of new fiber optic sensing technology.

In the exemplary embodiment, described in greater detail herein, the disclosed concept employs a convolutional neural network (CNN) based classification method that directly uses a time-space data matrix for the full distributed sensor system. Deep learning, specifically CNNs, has shown superior performance over traditional machine learning (ML) algorithms in many applications, including pipeline SHM and defect identification using distributed acoustic sensing (DAS) data. The use of CNNs in combination with DAS systems can greatly enhance the accuracy of SHM by providing real-time data analysis for detecting and identifying defects in pipelines. Unlike traditional ML algorithms, CNNs can automatically extract features from raw data and identify patterns that are difficult for humans or conventional algorithms to recognize. This capability is particularly beneficial for processing large amounts of data generated by DAS systems in real-time. CNN-based SHM systems can also adapt to changing conditions and automatically adjust their parameters to optimize performance, making them well-suited for complex environments where conventional approaches may be less effective. In short, the use of CNNs in combination with DAS systems according to the exemplary embodiment described herein has the potential to significantly improve pipeline SHM and defect identification by providing accurate and timely analysis of large amounts of sensor data.

In one aspect of the disclosed concept, the datasets used to train the CNN are generated through finite element simulation of guided wave signals, and include various types of damage severities and shapes relevant to common corrosion modes in pipelines. The simulations also incorporated varying levels of noise to emulate real-world conditions during sensor deployment. For model training and prediction, the disclosed concept utilizes a shallow-learning algorithm in thew form of a CNN. In the exemplary embodiment, the CNN model is relatively shallow, with only two convolutional layers and two pooling layers before flattening and passing the data through two fully connected layers. In general, deep neural networks contain many more layers, often tens or hundreds of layers, and are used to learn more complex features from data. However, even with its shallow architecture, the CNN model of the disclosed concept may be effective for the classification task if input features are not too complex or if there is not too much noise.

While the exemplary embodiment as just described employs a CNN, this is not meant to be limiting. Rather, other types of machine learning systems, including other types of artificial neural networks, may also be used to analyze the active sensor data and/or passive sensor data to detect defects in the pipeline.

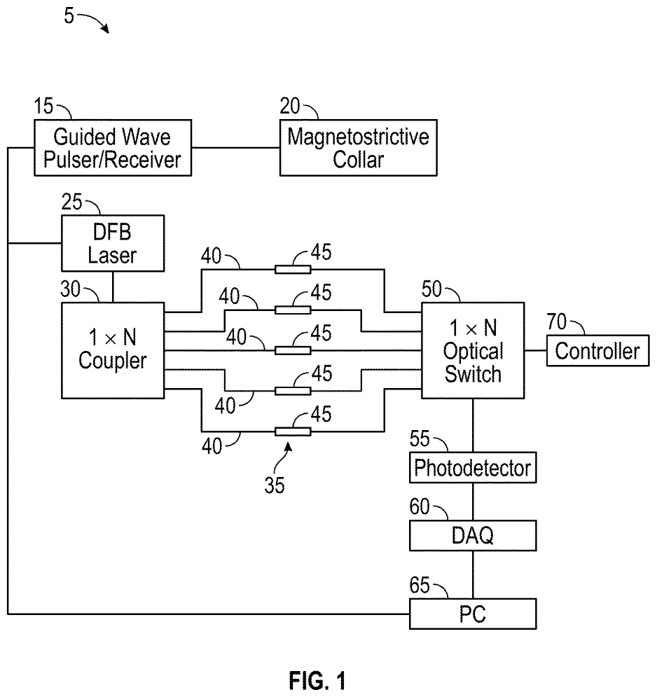

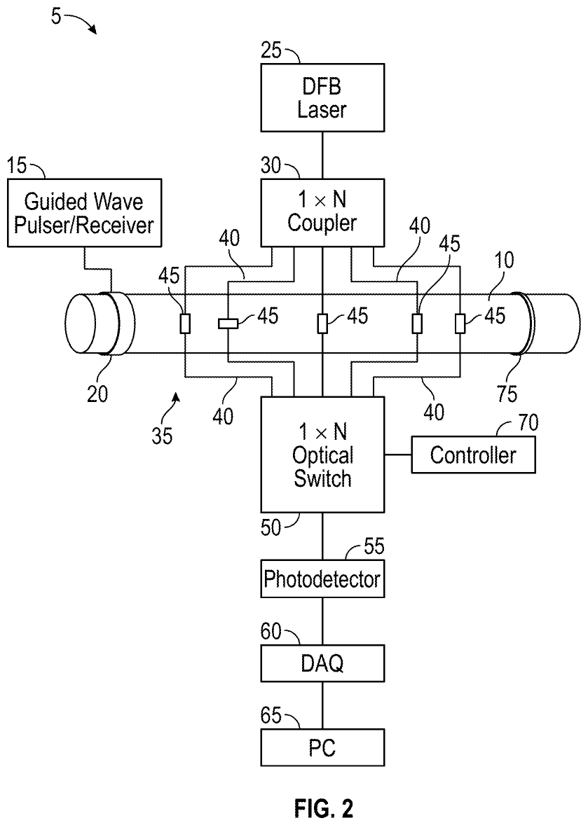

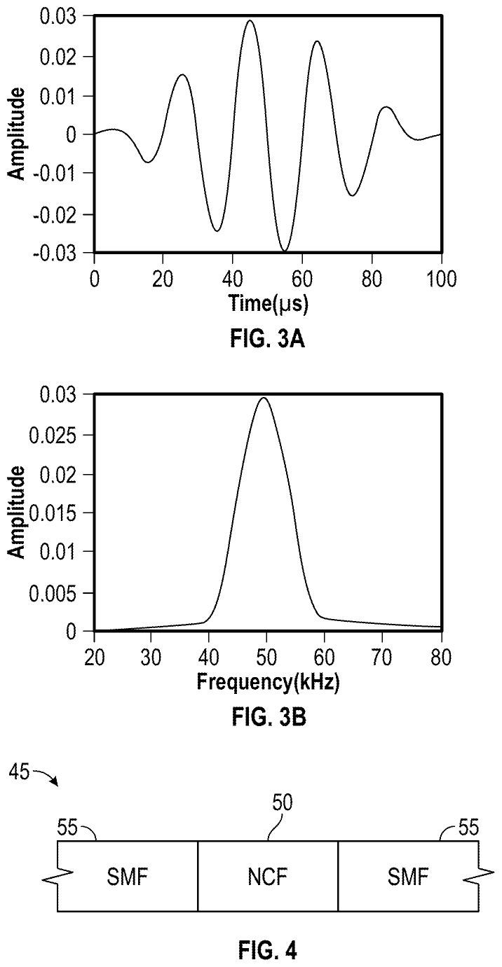

FIG. 1 is a schematic diagram of a pipeline infrastructure monitoring system 5 according to an exemplary embodiment of the disclosed concept. FIG. 2 is a schematic diagram of monitoring system 5 deployed in connection with an exemplary portion of pipeline 10 for monitoring the health status of pipeline 10. As seen in FIGS. 1 and 2, monitoring system 5 of the illustrated embodiment includes a guided wave pulser 15 that is coupled to an excitation coupling in the form of a magnetostrictive collar 20, although other types of couplings, such as piezoelectric collars, may also be used. Magnetostrictive collar 20 is coupled to the first end of pipeline 10. Guided wave pulser 15 and magnetostrictive collar 20 together are structured and configured for use in an active sensing method of the exemplary embodiment of the disclosed concept wherein ultrasonic guided waves (UGWs) are excited at the first end of pipeline 10 and propagate across the entire pipeline surface towards the second of pipeline 10. In the illustrated embodiment, guided wave pulser 15 is structured and configured to provide an excitation signal as shown in FIG. 3A (time domain) and FIG. 3B (frequency domain). In the exemplary embodiment, the excitation signal is a 50 kHz, 5-period/cycle sinusoidal signal modulated with a Hanning window in the axial direction, with an amplitude of 0.003 inches, representative of a typical excitation achievable with a guided wave collar:

$$u ( t ) = {\overline{u}}_{amp} ( 1 - cos \frac{2 π {f}_{c} t}{n} ) sin ( 2 π {f}_{c} t ) ;$$

where ūₐₘₚ is amplitude of the signal, f_{c} is frequency. Specifically, in the equation provided, n is the number of cycles of the signal that should be included in the excitation (based upon the Hanning window (period)). The assumed excitation amplitude is 0.003 inches, based on calibration between piezo actuator voltage and simulation excitation displacement.

Also in the exemplary embodiment, guided wave pulser 15 provides cylindrically symmetric UGWs. It will be understood, however, that this is meant to be exemplary only and that other types of alternative transducer methods to excite other types of UGWs may also be employed.

Referring again to FIGS. 1 and 2, monitoring system 5 includes a distributed feedback (DFB) laser 25 as a laser source (e.g., with an output power of 45 mW), a 1×N fiber coupler 30 coupled to the output of DFB laser 25, and a fiber structure assembly 35 coupled to the outputs of 1×N fiber coupler 30. Fiber structure assembly 35 includes a plurality of (e.g., five in the illustrated embodiment) fiber optic cable sensing devices 40 that are coupled in a manner such each of the N outputs of 1×N fiber coupler 30 is coupled to a respective one of the fiber optic cable sensing devices 40. Fiber optic cable sensing devices 40 may be a quasi-distributed fiber optic sensor or a distributed fiber optic sensor for sensing parameters such as temperature, strain, or another acoustic parameter. As illustrated, each fiber optic cable sensing device 40 of this exemplary embodiment is a quasi-distributed fiber optic strain sensor that includes one or more sensing elements 45 provided therein (a so-called in-fiber sensing element) or coupled thereto. The one or more sensing elements 45 may be, for example and without limitation, a multimode interferometer such as an SMS fiber structure, a fiber Bragg grating (FBG), a Fabry-Perot interferometer, a Mach-Zehnder interferometer (MZI), a piezoelectric sensor, an accelerometer, an acoustic emission sensor, or some combination thereof. The fiber optic cable sensing devices 40 are coupled to pipeline 10, and may be attached to the surface of pipeline 10, embedded within pipeline 10, or otherwise suitably coupled, directly or indirectly, to pipeline 10.

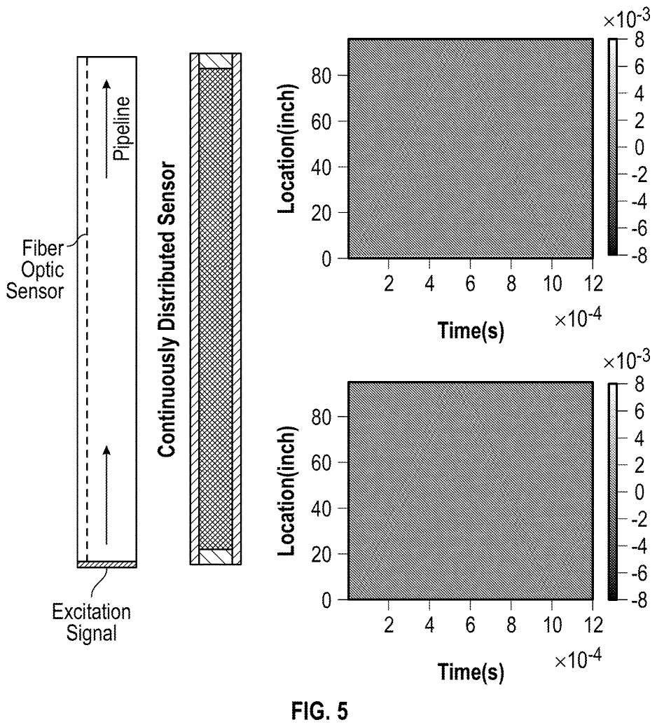

In the non-limiting exemplary embodiment shown in FIGS. 1 and 2, each sensing element 45 comprises an SNS fiber structure as shown in FIG. 4. As seen in FIG. 4, in the exemplary embodiment, the SNS fiber structure comprising sensing element 45 is formed by splicing a section 50 (e.g., a 5 cm long section) of NCF between two pieces of standard SMF 55. A customized core alignment fusion splicing program with appropriate fusion current and fusion time may be employed to line up the fibers to minimize the splice loss.

Referring again to FIG. 1, monitoring system 5 further includes a 1×N optical switch 50, a high-speed photodetector 55, a data acquisition (DAQ) unit 60 and a PC 65 with data processing software, such as LABVIEW™ software. In particular, the output of each fiber optic cable sensing device 40 is coupled to a respective one of the N inputs of 1×N optical switch 50. In the exemplary embodiment, 1×N optical switch 50 is a fast (e.g., 15 ms) optical switch that connects to the various fiber paths or channels by a micro-mechanical fiber to fiber auto-alignment platform that is activated via an electrical relay technique under the control of computer software running on a controller 70 provided as part of monitoring system 5. High-speed photodetector 55 is coupled to the single output of 1-N optical switch 50, and the output of high-speed photodetector 55 is coupled to the input of DAQ 60 and ultimately to PC 65. A second collar 75 may be provided at the second end of pipeline 10.

In operation, UGWs are excited at the first end of pipeline 10 by way of guided wave pulser/receiver 15 and magnetostrictive collar 20. A number of alternative excitation scenarios may also be used in the disclosed concept. This can include UGWs at different locations as well as a single point excitation source or a number of sensors at multiple locations. The UGWs propagate along the surface of pipeline 10 from the first side to the second side. However, due to wave dispersion and reflections from both ends of pipeline 10, the initial signal applied to pipeline 10 is decomposed into several different modes of wave packets propagating over the surface of pipeline 10. In addition, at the same time, the output of DFB laser 25 is split into N paths by 1×N fiber coupler 30. As a result, the output of DFB laser 25 is provided to each of the fiber optic cable sensing devices 40. Optical switch 50 is used to cycle the optical interrogation among the individual samples (the individual fiber optic cable sensing devices 40) as a function of time. At each point in the cycling, the output of the connected fiber optic cable sensing device 40 is provided to photodetector 55 and then to DAQ 60 and PC 65 for processing. In the exemplary embodiment, the sensor elements are placed at different locations on pipeline 10 in one or more orientations. In the illustrated exemplary embodiment, four fiber optic cable sensing devices 40 are wrapped circumferentially around the outer surface of pipeline 10, and a fifth fiber optic cable sensing device 40 is aligned along the longitudinal axis of pipeline 10. It will be appreciated that other configurations, such as specially wrapped configurations, many also be employed (including in various combinations). In this way the array of sensors provided by fiber structure assembly 35 works as a “quasi-distributed” sensor array. In addition, in an alternative implementation, rather than having a single photodetector 55 and 1×N optical switch 50, a system may include N photodetectors 55, each one coupled to a respective one of the fiber optic cable sensing device 40, with the outputs of the photodetectors 55 being provided to DAQ 60.

A number of exemplary processing techniques and components that may be used to implement the processing of the disclosed concept will now be described (i.e., the processing of the sensor signal(s) to identify and/or classify damage). Those exemplary processing techniques include techniques based on feature extraction, and techniques based on machine learning using a CNN for AI-based signal classification. Each of the techniques described herein may be implemented in/by a controller of PC 65 (or another suitable computing device) as one or more components thereof by the way of a number of computer executable software routines.

The exemplary embodiment employing a CNN is described below in connection with FIGS. 2, 5 and 6, which illustrates the workflow for sensor deployment and signal analysis, and the CNN architecture matrix for AI-based signal classification of this exemplary embodiment. The AI-based signal classification process employs a CNN to analyze the extracted features from the sensor data. The workflow consists of three main steps. The first step is a sensor deployment step wherein a number of sensors, such as fiber optic cable sensing devices 40, are strategically placed on a portion of a pipeline, such as pipecoline 10 as shown in FIG. 2, to capture the relevant signals for analysis. The next step is a time domain analysis step, wherein the acquired signals are mapped into a time-space data matrix, which serves as input to the CNN model. Alternatively, the input to the CNN model can both time domain data and frequency domain data as a function of position.

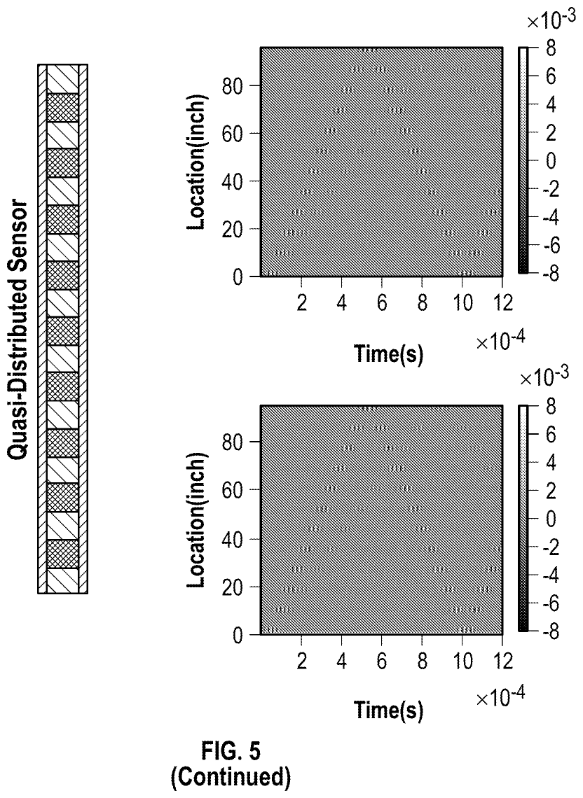

FIG. 5 depicts the time-space data matrix as input to the CNN network according to the exemplary embodiment. In the embodiment, the time-space data matrix is created by taking each time domain signal of each of the fiber optic cable sensing devices 40 along a certain spatial resolution limit as a separate row of the time-space data matrix. As seen in FIG. 5, the time-space data matrix is represented by a 2D time-space plot wherein an x-axis of the 2D time-space plot represents time and a y-axis of the 2D time-space plot represents a length of the portion of the pipeline. FIG. 5 illustrates such 2D time-space plots for two different exemplary sensor configurations, namely one employing quasi-distributed sensing and the other employing distributed sensing, and includes plots for each both without noise and with Gaussian noise (SNR=9.63 dB).

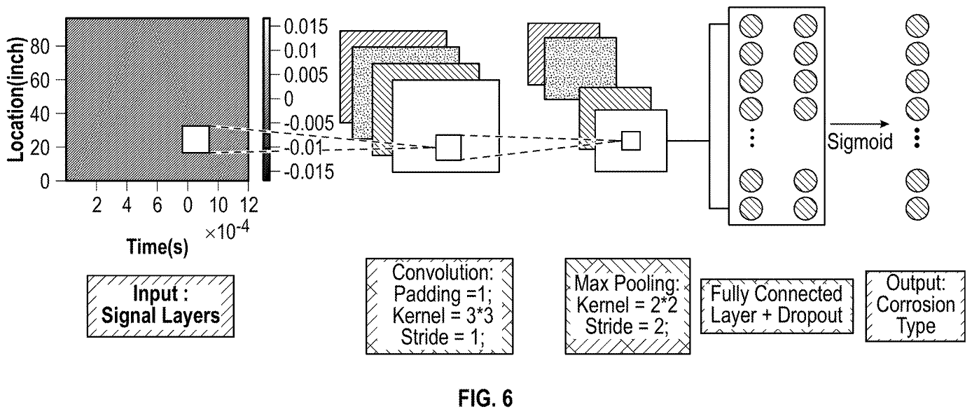

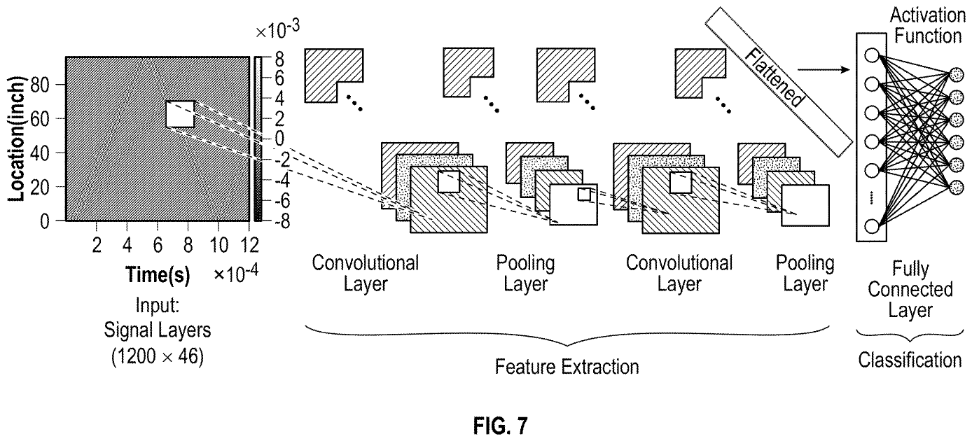

FIG. 6 is a schematic diagram of an exemplary CNN architecture that may be used to implement the disclosed concept. As seen in FIG. 6, the exemplary CNN architecture includes an input layer, a number of convolution layers, a number of max pooling layers, a number of fully connected layers, and an activation function In one particular, non-limiting exemplary embodiment, shown in FIG. 7, the CNN architecture includes the following layers: (i) two convolutional layers with 16 and 32 filters, respectively, and a kernel size of 10, (ii) a max pooling layer with a pool size of 2 following each of the convolutional layers to reduce the spatial dimensions of the feature maps, (iii) two fully connected layers with 64 and 6 neurons, respectively, which serve as the output layer for multi-class classification, and (iv) a softmax activation function applied to the output layer for transforming the output into probability scores for each class. The training process involves feeding simulated time-space data matrices into the network and adjusting the weights iteratively to minimize the loss function. In addition, the network is trained using categorical cross-entropy loss and a selected optimizer with a learning rate of 0.001 and batch size of 32. Once trained, the CNN model can be used to classify the health of a pipeline, such as pipeline 10, based on the data that is sensed, providing valuable information about the location, type, and size of the defects or damage.

In short, in this aspect, the disclosed concept includes the AI training process using a CNN for signal classification. The model takes the feature matrix derived from sensor data as an input and is trained to classify pipeline health based on the sensed data. This AI-based approach enhances the monitoring capabilities and provides valuable insights into the pipeline's health.

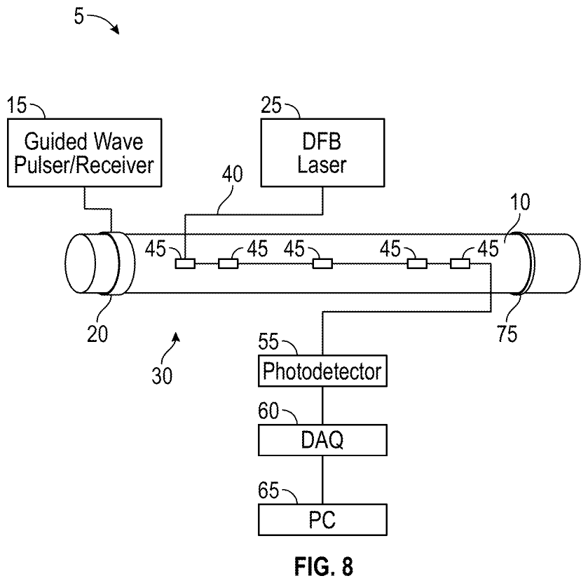

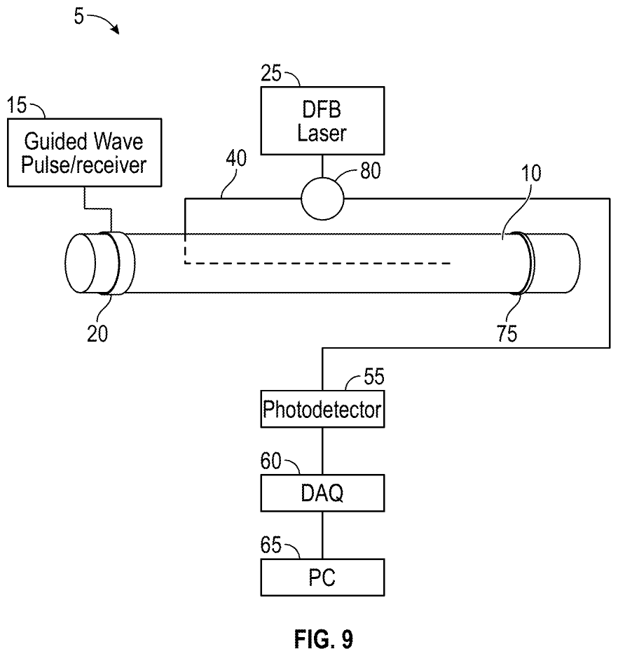

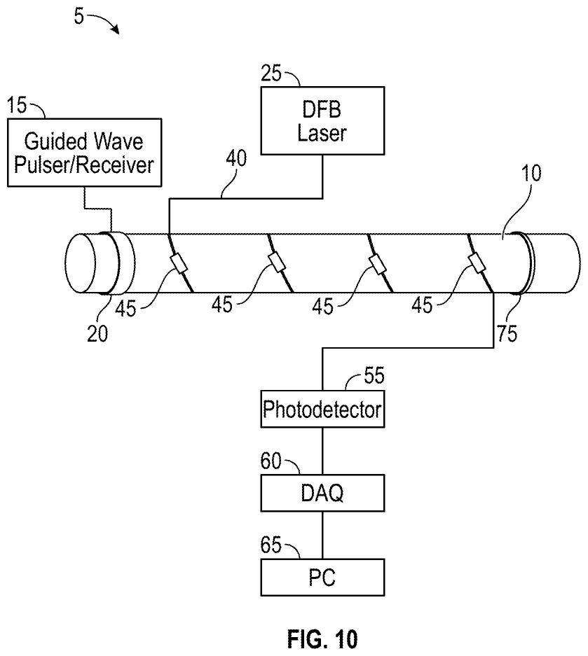

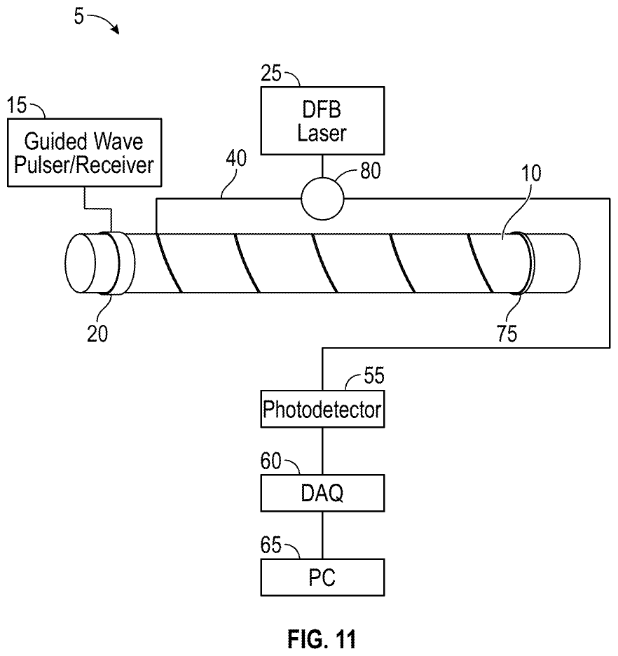

Furthermore, while certain embodiments described herein employ sensors oriented in a particular configuration around pipeline 10, it will be understood that that is meant to be exemplary only and not limiting. For example, and without limitation, FIGS. 8-11 depict a number of further embodiments of the disclosed concept that employ fully distributed or quasi-distributed sensor types, such as, without limitation, those employing FBGs or Fabry Perot interferometers in-line. It should be noted that in the case of the latter two examples, a single fiber can be deployed on pipeline 10, and the sensors are deployed all along the length of the fiber. Specifically, as noted elsewhere herein, for fully distributed sensing, it is often the fiber itself that acts as the sensor device/medium. Referring specifically to FIGS. 8-11, FIG. 8 depicts a configuration in which a quasi-distributed sensor is arranged axially along pipeline 10, FIG. 9 depicts a configuration in which a fully distributed sensor is arranged axially along pipeline 10, FIG. 10 depicts a configuration in which a quasi-distributed sensor is arranged spirally or helically along pipeline 10, and FIG. 11 depicts a configuration in which a fully distributed sensor is arranged spirally or helically along pipeline 10. In the case of a single fiber configuration, for interrogation of quasi-distributed sensors along the fiber, the disclosed concept may use time domain or wavelength domain multiplexing to obtain information from each sensor. Also, for certain fully distributed sensing embodiments that include a laser source and an interferometer, the sensing may be done from one end in a backscattering configuration using a circulator 80.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A system for monitoring structural health of a portion of a pipeline, comprising:
a wave assembly structured and configured for exciting the portion of the pipeline with acoustic waves;
a number of sensor assemblies coupled to the portion of the pipeline, each of the sensor assemblies including one or more fiber optic cable sensing devices;
a light source structured and configured for providing interrogation light to the number of sensor assemblies;
a detector coupled to the number of sensor assemblies, the detector being structured and configured for receiving an output of the number of sensor assemblies responsive to the interrogation light in an active mode of operation while the portion of the pipeline is being excited with the acoustic waves, and in response thereto generating active sensor data; and
a controller coupled to the detector, the controller being structured and configured for receiving the active sensor data, and for analyzing the active sensor data and detecting a defect in the portion of the pipeline based on the analyzing.

2. The system according to claim 1, wherein the wave assembly is an ultrasonic guided wave assembly structured and configured for exciting the portion of the pipeline with ultrasonic guided waves.

3. The system according to claim 2, wherein the ultrasonic guided wave assembly includes a guided wave pulser for generating the ultrasonic guided waves, and a magnetostrictive collar coupled to the portion of the pipeline for providing the ultrasonic guided waves to the portion of the pipeline.

4. The system according to claim 1, wherein each of a number of the fiber optic cable sensing devices is a quasi-distributed fiber optic sensor.

5. The system according to claim 1, wherein each of a number of the fiber optic cable sensing devices is a distributed fiber optic sensor.

6. The system according to claim 1, wherein each of a number of the fiber optic cable sensing devices includes multimode interferometer device.

7. The system according to claim 6, wherein the multimode interferometer device an SMS fiber structure.

8. The system according to claim 7, wherein each SMS structure is an SNS fiber structure.

9. The system according to claim 1, wherein the controller implements a machine learning system for analyzing the active sensor data and detecting the defect in the portion of the pipeline based on the analyzing.

10. The system according to claim 9, wherein the machine learning system comprises a trained convolutional neural network (CNN), wherein the analyzing comprises generating a time-space data matrix from the active sensor data, and providing the time-space data matrix to the CNN as an input, the CNN being trained to classify defects based on the time-space data matrix.

11. The system according to claim 10, wherein the time-space data matrix is created by taking each time domain signal of each of the fiber optic cable sensing devices along a certain spatial resolution limit as a separate row of the time-space data matrix.

12. The system according to claim 11, wherein the time-space data matrix is represented by a 2D time-space plot wherein an x-axis of the 2D time-space plot represents time and a y-axis of the 2D time-space plot represents a length of the portion of the pipeline.

13. The system according to claim 10, wherein the CNN comprises two convolutional layers a max pooling layer following each of the convolutional layers, two fully connected layers which serve as an output layer for multi-class classification, and a softmax activation function applied to the output layer for transforming an output of the output layer into probability scores for each class of the multi-class classification.

14. The system according to claim 10, wherein the CNN is trained with simulated data generated through finite element simulation using a physics based model.

15. The system according to claim 14, wherein the simulated data includes artificial noise.

16. A method of monitoring structural health of a portion of a pipeline, comprising:
coupling a number of sensor assemblies to the portion of the pipeline, each of the sensor assemblies including one or more fiber optic cable sensing devices;
exciting the portion of the pipeline with acoustic waves;
providing interrogation light to the number of sensor assemblies;
receiving an output of the number of sensor assemblies responsive to the interrogation light in an active mode of operation while the portion of the pipeline is being excited with the acoustic waves, and in response thereto generating active sensor data; and
receiving the active sensor data, and analyzing the active sensor data and detecting a defect in the portion of the pipeline based on the analyzing.

17. The method according to claim 16, wherein the acoustic waves are ultrasonic guided waves.

18. The method according to claim 17, further comprising using a magnetostrictive collar coupled to the portion of the pipeline for providing the ultrasonic guided waves to the portion of the pipeline.

19. The method according to claim 16, wherein each of a number of the fiber optic cable sensing devices is a quasi-distributed fiber optic sensor.

20. The method according to claim 16, wherein each of a number of the fiber optic cable sensing devices is a distributed fiber optic sensor.

21. The method according to claim 16, wherein each of a number of the fiber optic cable sensing devices includes a multimode interferometer device.

22. The method according to claim 21, wherein the multimode interferometer device is an SMS fiber structure.

23. The method according to claim 22, wherein each SMS structure is an SNS fiber structure.

24. The method according to claim 16, wherein the analyzing employs a machine learning system.

25. The method according to claim 24, wherein the machine learning system comprises a trained convolutional neural network (CNN), wherein the analyzing comprises generating a time-space data matrix from the active sensor data, and providing the time-space data matrix to the CNN as an input, the CNN being trained to classify defects based on the time-space data matrix.

26. The method according to claim 25, wherein the time-space data matrix is created by taking each time domain signal of each of the fiber optic cable sensing devices along a certain spatial resolution limit as a separate row of the time-space data matrix.

27. The method according to claim 25, wherein the time-space data matrix is represented by a 2D time-space plot wherein an x-axis of the 2D time-space plot represents time and a y-axis of the 2D time-space plot represents a length of the portion of the pipeline.

28. The method according to claim 25, wherein the CNN comprises two convolutional layers a max pooling layer following each of the convolutional layers, two fully connected layers which serve as an output layer for multi-class classification, and a softmax activation function applied to the output layer for transforming an output of the output layer into probability scores for each class of the multi-class classification.

29. The method according to claim 25, wherein the CNN is trained with simulated data generated through finite element simulation using a physics based model.

30. The method according to claim 29, wherein the simulated data includes artificial noise.

31. The system according to claim 1, wherein the detector is also structured and configured for receiving an output of the number of sensor assemblies responsive to the interrogation light in a passive mode of operation while the portion of the pipeline is not being excited with the acoustic waves, and in response thereto generating passive sensor data, and wherein the controller is structured and configured for receiving the passive sensor data, and wherein the analyzing comprises analyzing the active sensor data and the passive sensor data and detecting a defect in the portion of the pipeline based on the analyzing.

32. The method according to claim 16, further comprising receiving an output of the number of sensor assemblies responsive to the interrogation light in a passive mode of operation while the portion of the pipeline is not being excited with the acoustic waves, and in response thereto generating passive sensor data, and wherein the analyzing comprises analyzing the active sensor data and the passive sensor data and detecting a defect in the portion of the pipeline based on the analyzing.
